(19) United States
(12) Patent Application Publication
(10) Pub. No.: US 2023/0231716 A1
(43) Pub. Date: Jul. 20, 2023

(54) AUTONOMOUS MACHINE OPERATION WITH BLOCKCHAIN AUTHENTICATION

(71) Applicant: Ford Global Technologies, LLC, Dearborn, MI (US)

(72) Inventors: Pramita Mitra, West Bloomfield, MI (US); Hadi Atwi, Dearborn, MI (US); Spencer White, Dearborn, MI (US); Matthew Cassoli, Southgate, MI (US); Josh Fodale, Ypsilanti, MI (US)

(73) Assignee: Ford Global Technologies, LLC, Dearborn, MI (US)

(21) Appl. No.: 17/579,720

(22) Filed: Jan. 20, 2022

(51) Int. Cl. H04L 9/32; G06F 21/60; B25J 13/00

(52) U.S. Cl. CPC H04L 9/3213; G06F 21/602; B25J 13/006; H04L 2209/38

(57) ABSTRACT

A computer is configured to receive a request from an autonomous machine to perform an action, authenticate the autonomous machine according to a smart contract blockchain program, generate encrypted commands to actuate one or more components of the autonomous machine to perform the action in response to authenticating the autonomous machine, transmit the encrypted commands to an external server configured to authenticate the request according to a blockchain program, receive decrypted commands from the external server based on authentication of the request, and actuate the one or more components of the autonomous machine to perform the action according to the decrypted commands.

### FIELD

The present disclosure relates to operation of autonomously operable machines, particularly data security for the machines.

### BACKGROUND

The statements in this section merely provide background information related to the present disclosure and may not constitute prior art.

Autonomous machines (e.g., autonomous guided vehicles (AGV), autonomous mobile robots (AMR), among others)) assist in manufacturing parts and may operate with little to no input from a human operator. The autonomous machines can perform various tasks during a manufacturing process. For example, an AMR can operate an additive printer that is programmed to print a part. In some applications, operation of the autonomous machines may be controlled using generic data and/or proprietary data. The proprietary data is provided at the autonomous machine with the generic data and can be easily accessible by unauthorized individuals.

The present disclosure addresses challenges with operating autonomous machines.

### SUMMARY

This section provides a general summary of the disclosure and is not a comprehensive disclosure of its full scope or all of its features.

In one form, a computer includes a processor and a memory, the memory storing instructions executable by the processor to receive a request from an autonomous machine to perform an action, authenticate the autonomous machine according to a smart contract blockchain program, generate encrypted commands to actuate one or more components of the autonomous machine to perform the action in response to authenticating the autonomous machine, transmit the encrypted commands to an external server configured to authenticate the request according to a blockchain program, receive decrypted commands from the external server based on authentication of the request, and actuate the one or more components of the autonomous machine to perform the action according to the decrypted commands.

In variations of the system, which may be implemented individually or in any combination: the instructions further include instructions to generate the encrypted commands according to a command generation algorithm, the command generation algorithm being encrypted in the memory; the computer includes a first module and a second module in communication with the first module, wherein: the first module is configured to generate the request and to transmit the request to the second module, and the second module is configured to execute the smart contract blockchain program in response to receiving the request; the second module is programmed with a cryptographic program to generate the encrypted commands; the request includes an access token associated to the autonomous machine and the instructions further include instructions to authenticate the access token with the smart contract blockchain program; the computer is housed in the autonomous machine; the instructions further include instructions to authenticate the autonomous machine based on data in the request; the request includes data describing a machine to manufacture a part and the instructions further include instructions to authenticate the request based on the data describing the machine; the instructions further include instructions to receive authentication of the request from the external server, the authentication based on at least one of: data in the request describing the part to be manufactured, data describing a facility in which the autonomous machine is located, or the data describing the machine; to generate the encrypted commands, the instructions further include instructions to: generate commands to perform the action; and encrypt the commands with an encryption key to generate the encrypted commands; the system further includes an external server in communication with the computer; the external server is further configured to authenticate the encrypted commands based on data included in the request; the data included in the request include at least one of data describing a part to be manufactured, data describing a facility in which the autonomous machine is located, or data describing a machine to manufacture the part; the instructions further include instructions to append the request to a blockchain ledger of the smart contract blockchain program.

In one form, a method includes receiving a request from an autonomous machine to perform an action, authenticating the autonomous machine according to a smart contract blockchain program, generating encrypted commands to actuate one or more components of the autonomous machine to perform the action in response to authenticating the autonomous machine, transmitting the encrypted commands to an external server configured to authenticate the request according to a blockchain program, receiving decrypted commands from the external server based on authentication of the request, and actuating the one or more components of the autonomous machine to perform the action according to the decrypted commands.

In variations of the method, which may be implemented individually or in combination: the method further includes generating the encrypted commands according to a command generation algorithm, the command generation algorithm being encrypted; the request includes an access token associated to the autonomous machine and the method further includes authenticating the access token with the smart contract blockchain program; the method further includes authenticating the autonomous machine based on data in the request; the data included in the request include at least one of data describing a part to be manufactured, data describing a facility in which the autonomous machine is located, or data describing a machine to manufacture the part; the method further includes appending the request to a blockchain ledger of the smart contract blockchain program.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram of an example system for operating an autonomous machine in accordance with the present disclosure;

FIG. 2 is a block diagram of the autonomous machine in accordance with the present disclosure;

FIG. 3 is a block diagram of a server in communication with the autonomous machine in accordance with the present disclosure; and

FIG. 4 is a flowchart of an example process for operating the autonomous machine in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a hardware security module that protects proprietary data from unauthorized users. In one form, the hardware security module uses a smart contract module configured to reference a blockchain ledger to authenticate and validate a request to perform an action that is based on proprietary data. By authenticating the request, the hardware security module reduces a likelihood of unauthorized access to proprietary data and verifies that the request is authentic. The blockchain ledger provides additional authentication and validation by providing network entity endorsement policies and historical tracing of previous requests, authenticating the veracity of the data of the request against the blockchain ledger. Upon authenticating the request, the hardware security module generates encrypted commands indicative of the proprietary data to perform the action.

As used herein, proprietary data may include software programs, algorithms, and/or data models, among other proprietary information employed to have an autonomous machine perform an action.

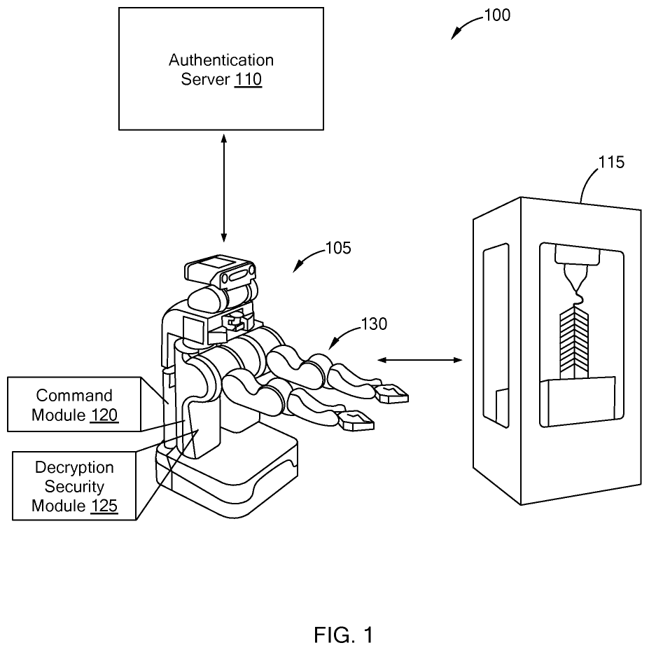

With reference to FIG. 1, a system 100 includes an autonomous machine 105, an authentication server 110, and a manufacturing machine 115. The autonomous machine 105 receives commands from the server 110 and performs an action on the manufacturing machine 115. In one form, an “action” is an operation of the autonomous machine 105 that provides a specified outcome such as, but not limited to: adjusting parameters of the additive manufacturing machine, installing/removing fixtures, and/or adding material to the machine. The autonomous machine 105 performs the action with little to no input from a human operator (i.e., in an “autonomous” manner).

In a non-limiting example, as illustrated in FIG. 1, the autonomous machine 105 is an autonomous moveable robot (AMR) that performs the action. The AMR is partially or fully autonomous and is configured to autonomously move to various locations of a manufacturing facility. To autonomously move itself, the AMR is configured to control various movement systems (e.g., propulsion systems, steering systems, and/or brake systems) based on one or more autonomous navigation sensors (e.g., a global navigation satellite system (GNSS) sensor, an imaging sensor, a local position sensor, among others). Furthermore, the AMR is configured to operate the actuators to control the motion of one or more robotic links (e.g., robotic arms) attached thereto and thereby perform one or more automated tasks. The automated tasks may refer to one or more motions the AMR performs to achieve a desired result (e.g., removing a part from a bin, loading a workpiece into a fixture, transporting a payload from one location to another, among others). While the autonomous machine 105 is provided as an AMR, it should be readily understood that the present disclosure is applicable to other autonomous machines such as, but not limited to, fixed robots and/or autonomous guided vehicles (AGV).

In one form, the autonomous machine 105 includes a command module 120, a decryption security module 125, and one or more components 130. The command module 120 and the decryption security module 125 are housed in the autonomous machine 105. The “components” are subsystems or other parts of the autonomous machine 105, as described above, that physically perform the action. For example, the components 130 may include a movable arm, a motor, and/or, and the command module 120 is configured to provide commands to a linear actuator to move the arm toward the manufacturing machine 115. In another example, the command module 120 provides commands to the movable arm to rotate a component on the additive manufacturing machine 115.

The authentication server 110 is a computer including a processor and a memory that is separate from the autonomous machine 105. The authentication server 110 communicates with the autonomous machine 105 via a wireless network such as Wi-Fi, Bluetooth®, cellular, etc. The authentication server 110 is configured to authenticate and validate the facility in which the autonomous machine 105 is located by comparing data provided by the autonomous machine 105 to a blockchain ledger, as described below, and to decrypt the commands upon the authentication and validation. The authentication server 110 is located separate from the autonomous machine 105 (e.g., in a same facility as the autonomous machine 105, or in a different facility than the autonomous machine 105). The authentication server 110 can be a “central” or “external” server 110 that manages requests from a plurality of autonomous machines 105 located at a plurality of facilities. Alternatively, the authentication server 110 can include a plurality of computers communicatively connected to each other (i.e., a cloud computing system).

In one form, the manufacturing machine 115 manufactures an object, such a part for a vehicle. For example, the manufacturing machine 115 can be an additive manufacturing machine that manufactures the object according to an additive process such as a three-dimensional printing process by which layers of material are deposited onto each other to form a three-dimensional object. In another example, the manufacturing machine 115 uses a different manufacturing method such as injection molding, lathing, tooling, stamping, pressing, etc. In one form, the manufacturing machine 115 receives the action from the autonomous machine 105. The manufacturing machine 115 may include an input device such as a button or a dial to receive manual input from a human operator, and the action from the autonomous machine 105 can be providing physical input to the input device, such as pushing the button or turning the dial.

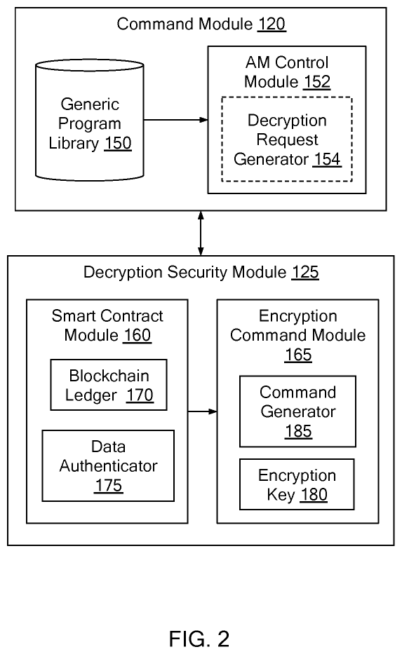

Referring to FIG. 2, in one form, the command module 120 and the decryption security module 125 are communicably coupled via, for example, a wired or wireless communication link. Accordingly, the modules 120 and 125 include hardware (e.g., input-output interface, communication bus, wires, transceivers) and software programs for establishing communication with one another. In a non-limiting example, the command module 120 and the decryption security module 125 are implemented using one or more computing devices (i.e., a computer(s)). The command module 120 is configured to execute software programs defined as series of commands to have the autonomous machine 105 perform various actions. In some instances, the command module 120 executes commands indicative of proprietary data provided by the decryption security module 125, and as described herein, requests commands indicative of the proprietary data from the decryption security module 125.

In one form, the command module 120 is configured to include a program library 150 and an AM control module 152 having a decryption request generator 154. The program library 150 stores generic programs to be executed by the execution module 152 to have the autonomous machine perform various actions.

The AM control module 152 is configured to control the components of the AM to have the AM perform various actions. In one form, the AM control module 152 includes a set of instructions executable by a microprocessor and configured to execute generic programs stored in the library 150 and also commands from the description security module 125. More particularly, the set of instructions may refer to a proprietary data to be executed, and the decryption request generator 154 generates a request to obtain the generic code for the proprietary data from the decryption security module 125.

In one form, the request generated by the decryption request generator 154 includes proprietary identification (ID) data for identifying the proprietary data being requested for performing the action (e.g., a name associated with the proprietary data, an alphanumeric code) and requester verification data to authenticate and validate the request. As used herein, to “authenticate” means to ensure the veracity of data, and to “validate” means to approve the data. That is, “authentication” of data means that the data therein is genuine, and “validation” of the data means that the data is permitted for use.

In one form, the request can include an access token associated to the autonomous machine 105, as the requester verification data. The access token is an alphanumeric string that uniquely identifies the autonomous machine 105. In another example, the requester verification data of the request can include data related to the manufacturing machine 115 that is to manufacture the part (e.g., a machine identification code, a machine name, the original equipment manufacturer of the machine 115), data related to the part to be manufactured (e.g., work order associated with the part, part ID and/or part name), data related to number of parts to be manufactured, and/or data describing a facility in which the autonomous machine 105 is located. While specific examples of requester verification data are provided, other type of data may be used to authenticate and validate the request. In one form, the validation data can be retrieved by the decryption request generator 154 from a remote server, data can be prestored in the command module 120, and/or the data can be inputted by a human user. The decryption request generator 154 is configured to generate the request with appropriate requester verification data and transmits the request to the decryption security module 125.

The decryption security module 125 is an encrypted module, such as a hardware security module (HSM) that is configured to protect the proprietary data employing a cryptographic program. The decryption security module 125 can be configured with one or more anti-tampering measures to further secure the data.

In one form, the decryption security module 125 includes a smart contract blockchain module 160 and an encryption command module 165. The smart contract module 160 (referred to herein as “smart contract” 160) is configured to authenticate and validate the autonomous machine 105 upon receiving the request and the encryption command module 165 generates encrypted commands in response to the request being authenticated and validated.

In one form, the smart contract 160 includes a blockchain ledger 170 and a data authenticator 175. In an example application, the blockchain ledger 170 is a ledger stored in the memory of the decryption security module 125 that includes data to authenticate the autonomous machine 105. The blockchain ledger 170 improves security of data used to authenticate the request by providing network entity endorsement policies and historical tracing of previous requests and authenticating the veracity of the data within the blockchain ledger 170. The data authenticator 175 searches the blockchain ledger 170 for the requester verification data provided in the request to authenticate and validate the request. For example, the data authenticator program 175 can authenticate the access token in the request by searching for data indicating issuance of the access token in the blockchain ledger 170, and upon finding the issuance data, the data authenticator 175 determines that the request is authentic and validates the request based on the authenticated access token.

In another variation, the data authenticator 175 authenticates the autonomous machine 105 and the request based on the data related to the manufacturing machine 115 that is requested to manufacture the part, data related to the part to be manufactured, and/or data related to the facility in which the autonomous machine 105 is located. Upon identifying data in the blockchain ledger 170 matching data in the request, the data authenticator 175 can authenticate and validate the autonomous machine 105 and the request. Following authentication of the request, the data authenticator 175 appends the request to the blockchain ledger 170. If the data authenticator 175 searches the blockchain ledger 170 and does not find the requester verification data in the request, the data authenticator program 175 outputs that the request is not authenticated, and the6 command module 120 does not perform the action in the request. The data authenticator 175 then appends the request and the failed authentication to the blockchain ledger 170.

Once the request is authenticated and validated, the encryption command module 165 is configured to generate encrypted commands of the proprietary data requested in the request. In one form, the encryption command module 165 includes a command generator 185 and an encryption key 180. The command generator 145 is configured to provide the encrypted commands related to the proprietary data requested in the request. For example, the command generator 185 generates the commands associated with the proprietary ID data in the request. The encryption key 140 is a numerical string used in a conventional encryption program to encrypt the command of proprietary data. The command generator 185 is a command generation algorithm that is encrypted in the memory to inhibit unauthorized devices/users from accessing the proprietary data used to generate the commands. The command generator 185 first generates unencrypted commands indicative of the proprietary data and then applies known cryptographic program to encrypt the commands with the encryption key 140. Accordingly, the encryption command module 165 generates encrypted commands of the proprietary data requested in the request and transmits the encrypted commands to the6 command module 120.

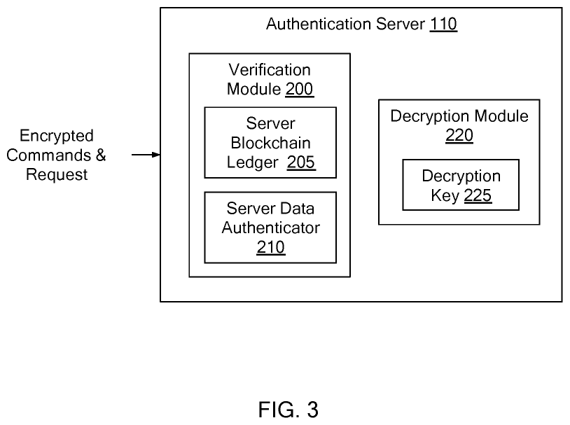

With reference to FIG. 3, the authentication server 110 receives the request and the encrypted commands from the command module 120 and transmits decrypted commands to the command module 120. In one form, the authentication server 110 is configured to include a verification module 200 and a decryption module 220. The verification module 200 is configured to authenticate the request and includes a server blockchain ledger 205 and a server data authenticator 210. In one form, similar to the decryption security module 125, the server blockchain ledger 205 includes data for authenticating the request such as, but not limited to: data related to one or more proprietary data authorized to be used, one or more authorized facilities, one or more authorized parts to be manufactured, and/or one or more manufacturing machines that is to manufacture the part.

In one form, the server data authenticator 210 is configured to authenticate and validate the request based on data included in the request (e.g., proprietary ID data and requester verification data) and data in the server blockchain ledger 205. For example, the server data authenticator 210 is configured to compare the data in the request to data in the server blockchain ledger 205. If the data in the request matches data in the server blockchain ledger 205, the server data authenticator 210 determines that the request is authentic and has the decryption module 220 decrypt the encrypted command. Otherwise, the server data authenticator 210 determines that the request is not authentic and may notify the command module 120 of the same.

The decryption module 220 is configured to include a decryption key 225 for decrypting the encrypted command from the command module 120. More particularly, in one form, the decryption module 220 is configured to employ a cryptographic decryption program to decrypt the encrypted commands 155 using the decryption key 225 that is paired with the encryption key 180 of the encryption command module 185. For example, the encryption key 180 and the decryption key 225 are a pair of keys used in a conventional asymmetric key encryption program. In another example, the encryption key 180 and the decryption key 225 are a same key used in a conventional symmetric key encryption program.

Using the decryption security module 125 and the authentication server 110 to authenticate the request to perform the action with encrypted commands, proprietary data stored in autonomous machine 105 is protected from unauthorized users. The multiple blockchain ledgers 170, 205 provide additional security and record tracking for requests and use of the proprietary data. As such, manufacturers of the autonomous machines 105 can include proprietary information such as advanced algorithms for operating the autonomous machine 105 for use in locations where otherwise unauthorized users may interact with the autonomous machine 105.

In another variation, the smart contract 160 appends each use of the proprietary instructions by the autonomous machine 105 to the blockchain ledger 170. A developer of the proprietary instructions may inspect the blockchain ledger 170 to determine when and how the autonomous machine 105 implemented the proprietary instructions. For example, the developer can charge a user of the autonomous machine 105 based on a number of times that the proprietary instructions were implemented as recorded in the blockchain ledger 170. The decryption security module 125 can encrypt the usage data with the encryption key 180 and transmit the encrypted usage data to the authentication server 110. The developer can decrypt the encrypted usage data with the decryption key 225 for managing operation and invoicing of the user of the autonomous machine 105.

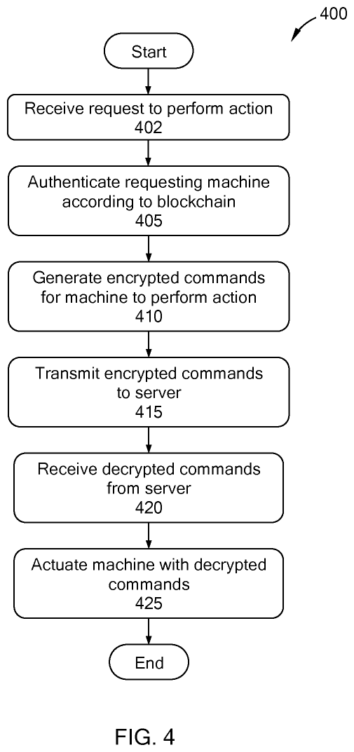

FIG. 4 illustrates an example routine 400 for operating an autonomous machine 105. At 402, the decryption security module 125 of the autonomous machine 105 receives a request from the command module 120 of the autonomous machine 105 to perform an action on the manufacturing machine 115.

Next, at 405, the decryption security module 125 authenticates the autonomous machine 105 providing the request based on data in the blockchain ledger. As described above, the smart contract module 160 compares data in the request to the blockchain ledger 170, and a data authenticator 175 outputs an authentication based on the comparison.

Next, at 410, the encryption command module 165 of the decryption security module 125 generates encrypted commands for the proprietary data requested to perform the action. As described above, the encryption command module 165 generates the commands and encrypts the commands with a cryptographic program using an encryption key 180. Upon generating the encrypted commands, the decryption security module 125 transmits the encrypted commands to the command module 120.

Next, at 415, the command module 120 transmits the encrypted commands 155 and the decryption request to the authentication server 110. The authentication server 110 is a computer separate from the autonomous machine 105.

Next, at 420, the command module 120 receives decrypted commands for the proprietary data from the authentication server 110 if the request is authenticated by the server 110, as described above. The authentication server 110 decrypts the encrypted commands 155 with a decryption module 220 including a decryption key 225 and sends the decrypted commands to the command module 120.6

Next, at 425, the command module 120 actuates one or more components 130 to perform the action on the additive manufacturing machine 115 according to the decrypted commands. For example, the command module 120 can actuate a linear actuator to move an arm to a specified location to engage the manufacturing machine 115. It should be readily understood that the routine 400 is just one example for authenticating and verifying the request as described herein, and other suitable routines may be employed.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system comprising:
a computer including a processor and a memory, the memory storing instructions executable by the processor to:
receive a request from an autonomous machine to perform an action;
authenticate the autonomous machine according to a smart contract blockchain program;
generate encrypted commands to actuate one or more components of the autonomous machine to perform the action in response to authenticating the autonomous machine;
transmit the encrypted commands to an external server configured to authenticate the request according to a blockchain program;
receive decrypted commands from the external server based on authentication of the request; and
actuate the one or more components of the autonomous machine to perform the action according to the decrypted commands.

2. The system according to claim 1, wherein the instructions further include instructions to generate the encrypted commands according to a command generation algorithm, the command generation algorithm being encrypted in the memory.

3. The system according to claim 1, wherein the computer includes a first module and a second module in communication with the first module, wherein:
the first module is configured to generate the request and to transmit the request to the second module, and
the second module is configured to execute the smart contract blockchain program in response to receiving the request.

4. The system according to claim 3, wherein the second module is programmed with a cryptographic program to generate the encrypted commands.

5. The system according to claim 1, wherein the request includes an access token associated to the autonomous machine and the instructions further include instructions to authenticate the access token with the smart contract blockchain program.

6. The system according to claim 1, wherein the computer is housed in the autonomous machine.

7. The system according to claim 1, wherein the instructions further include instructions to authenticate the autonomous machine based on data in the request.

8. The system according to claim 7, wherein the request includes data describing a machine to manufacture a part and the instructions further include instructions to authenticate the request based on the data describing the machine.

9. The system according to claim 8, wherein the instructions further include instructions to receive authentication of the request from the external server, the authentication based on at least one of: data in the request describing the part to be manufactured, data describing a facility in which the autonomous machine is located, or the data describing the machine.

10. The system according to claim 1, wherein to generate the encrypted commands, the instructions further include instructions to:
generate commands to perform the action; and
encrypt the commands with an encryption key to generate the encrypted commands.

11. The system according to claim 1 further comprising an external server in communication with the computer.

12. The system according to claim 11, wherein the external server is further configured to authenticate the encrypted commands based on data included in the request.

13. The system according to claim 12, wherein the data included in the request include at least one of data describing a part to be manufactured, data describing a facility in which the autonomous machine is located, or data describing a machine to manufacture the part.

14. The system according to claim 1, wherein the instructions further include instructions to append the request to a blockchain ledger of the smart contract blockchain program.

15. A method, comprising:
receiving a request from an autonomous machine to perform an action;
authenticating the autonomous machine according to a smart contract blockchain program;
generating encrypted commands to actuate one or more components of the autonomous machine to perform the action in response to authenticating the autonomous machine;
transmitting the encrypted commands to an external server configured to authenticate the request according to a blockchain program;
receiving decrypted commands from the external server based on authentication of the request; and
actuating the one or more components of the autonomous machine to perform the action according to the decrypted commands.

16. The method according to claim 15, further comprising generating the encrypted commands according to a command generation algorithm, the command generation algorithm being encrypted.

17. The method according to claim 15, wherein the request includes an access token associated to the autonomous machine and the method further includes authenticating the access token with the smart contract blockchain program.

18. The method according to claim 15, further comprising authenticating the autonomous machine based on data in the request.

19. The method according to claim 18, wherein the data included in the request include at least one of data describing a part to be manufactured, data describing a facility in which the autonomous machine is located, or data describing a machine to manufacture the part.

20. The method according to claim 15, further comprising appending the request to a blockchain ledger of the smart contract blockchain program.
